(19) United States
(12) Patent Application Publication
(10) Pub. No.: US 2010/0032257 A1
(43) Pub. Date: Feb. 11, 2010

(54) COMPACT BRAKE

(75) Inventor: Lennart Stridsberg, Stockholm (SE)

Correspondence Address: BIRCH STEWART KOLASCH & BIRCH, PO BOX 747, FALLS CHURCH, VA, 22040-0747, US

(73) Assignee: Stridsberg Innovation AB, Stockholm (SE)

(21) Appl. No.: 12/302,878

(22) PCT Filed: May 31, 2007
(86) PCT No.: PCT/SE2007/000532

§ 371 Date: Oct. 22, 2009

(30) Foreign Application Priority Data
May 31, 2006 (SE) 0601229-8
Aug. 16, 2006 (SE) 0601731-3
Aug. 24, 2006 (SE) 0601809-7

(51) Int. Cl. F16D 27/102

(52) U.S. Cl. 192/40

(57) ABSTRACT

An electrically controlled brake or clutch includes a rotatable first mechanical system (101, 108) and a second mechanical system that is stationary for the case of a brake but rotatable for the clutch case. In the second system windings are wound around two soft magnetic parts (102, 103) so that electric current flowing in the windings affects magnetic fluxes through the soft magnetic parts to move them in a direction that affects the effective length of an air gap in the closed main magnetic path. A spring (401) creates a force acting in a direction opposite that of the attraction force. The soft magnetic parts are arranged so that the main magnetic flux path passes along a closed loop about the rotational axis of the first mechanical system, this giving a compact design of the brake or clutch.

### RELATED APPLICATIONS

This application claims priority and benefit from Swedish patent applications Nos. 0601229 8, filed May 31, 2006, 06017131-3, filed Aug. 16, 2006, and 0601809-7, filed Aug. 24, 2006, the entire teachings of which are incorporated herein by reference.

### TECHNICAL FIELD

The present, invention is concerned with brakes, in particular holding brakes for servo motors.

### BACKGROUND

Servo motors are often used in applications where it is important that they will not move during power off or when there is reason to assume that the control system of the servo motor is not behaving properly, for example when an emergency stop button has been pressed.

### SUMMARY

It is an object of the invention to provide a brake or clutch that that at least in some embodiments can have a compact shape.

It is another object of the invention to provide a brake or clutch that at least in some embodiments can be produced in a cost-efficient way.

An electrically controlled brake that can also be used or designed as a clutch includes as conventional a rotatable first mechanical system having one or more friction parts/surfaces and a second mechanical system that has one or more friction parts/surfaces. The friction surfaces can made to come in contact with each other, providing a braking or coupling effect, and be withdrawn from each other releasing the brake or clutch. The second mechanical system is stationary for the case of a brake and is rotatable for the clutch case. Electric windings are provided, e.g. wound around two soft magnetic parts, and are arranged so that electric current flowing in the windings affects magnetic fluxes through the soft magnetic parts to move at least one thereof. The movement is in a direction that affects the effective length of one or more air gaps in the closed main magnetic path created by the current and the soft magnetic parts. In particular the electric current gives attraction forces over the air gap or gaps which forces tend to move one of or both the soft magnetic parts to reduce the length of the air gap. One or more springs create forces acting in a direction substantially opposing the attraction forces. In the movement the friction part of the first mechanical system comes in frictional engagement or frictional disengagement with the friction part of the second mechanical system. Frictional disengagement here means that a frictional engagement between the two mechanical system is released.

The soft magnetic parts are arranged so that the main magnetic flux path passes along a closed loop that passes about the rotational axis of the first mechanical system, this making it possible to e.g. give the brake or clutch a compact design.

The soft magnetic parts can together have a toroidal shape having e.g. substantially the same axis as the rotational axis.

Additional objects and advantages of the invention will be set forth in the description which follows, and in part will be obvious from the description, or may be learned by practice of the invention. The objects and advantages of the invention may be realized and obtained by means of the methods, processes, instrumentalities and combinations particularly pointed out in the appended claims.

### BRIEF DESCRIPTION OF THE DRAWINGS

While the novel features of the invention are set forth with particularly in the appended claims, a complete understanding of the invention, both as to organization and content, and of the above and other features thereof may be gained from and the invention will be better appreciated from a consideration of the following detailed description of non-limiting embodiments presented hereinbelow with reference to the accompanying drawings, in which:

FIG. 1 is a front view of a normally active, asymmetrical, angular movement brake in its braking state,

FIG. 2 is similar to FIG. 1 but shows the brake in its non-braking state,

FIG. 3 is a front view of the magnetically permeable parts of the brake of FIGS. 1 and 2,

FIG. 4 is a front view of a flat spring arrangement for the brake of FIGS. 1 and 2,

FIG. 5 is front view similar to FIG. 1 of the brake including flat springs as shown in FIG. 4,

FIG. 6 is a cross-sectional view in an axial plane of the brake of FIGS. 1 and 2 assembled inside the rotor of an electric motor,

FIG. 7 is a front view of a normally active, symmetrical, angular movement brake in its braking state,

FIG. 8 is a front view of the magnetically permeable parts of a parallel movement brake,

FIG. 9 is a front view of a flat spring suitable for the brake parts of FIG. 8

FIG. 10 is a cross-sectional view in radial plane of a parallel movement brake having internal linear guides,

FIG. 11 is a front view of the brake of FIG. 10 including windings,

FIG. 12 is a cross-sectional view in a radial plane of a parallel movement brake including air gap mounted springs,

FIG. 13 is a perspective view of the brake of FIG. 12, and

FIG. 14 is similar to FIG. 12 showing a brake that is active (braking) when a control current is active.

### DETAILED DESCRIPTION

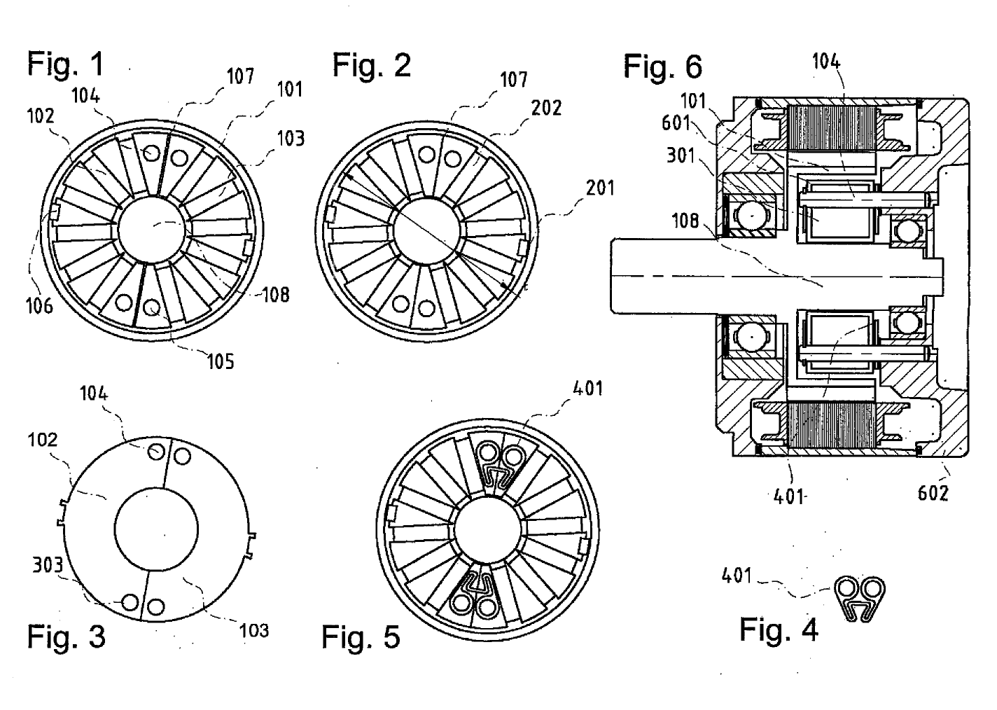

FIG. 1 is a front view of a normally active brake in the braking state thereof. The brake consists of two groups of components. The first group is connected to a rotating device, for example the rotor of a motor. In the case shown, there are only two components in this group including the hollow circular cylinder or drum, 101 and the central shaft 108. The other group is normally connected to a non-rotating or stationary part such as a motor frame. There are two main components in this group, the half-arcs 102 and 103, each of which has the shape of the half of cylindrical ring, i.e. a cylindrical ring segment corresponding to an angle of substantially 180°. These two parts can rotate within a very limited angle around magnetically permeable shafts 104 and 105, respectively, the shafts located at axially opposite positions near one of the flat axial surfaces of the half-arc. FIG. 1 shows the two half-arcs where each thereof has been rotated in the clockwise direction around its shaft to take its maximum clockwise position. The movement of the first half-arc 102 is limited to the position where the brake lining pad 106 of high friction material on the envelope surface of the half-arc comes in contact with the interior envelope curved surface of the hollow cylinder 101. The movement of the second half-arc 103 is limited in the same way. As a consequence of these two movements, there are two air gaps like 107 between the two half-arcs. The force required to move the two half-arcs 102, 103 clockwise around their respective shafts 104, 105 can be arranged by springs configured e.g. as that shown in FIG. 5.

FIG. 2 shows the two half-arcs 102, 103 where each half-arc has been rotated around its shaft in the counter-clockwise direction to take its maximum counter-clockwise position. The movement of the first half-arc 102 is limited to the position where it is pressed against the second half-arc 103. The movement of the second half-arc 103 is limited in the same way. As a consequence of these two movements, there is practically no gap 107 between the two half-arcs in this state. Consequently, there will appear a gap 201 between the brake lining 106 and the interior cylindrical surface of the brake drum 201. The force required to move the two half-arcs counter-clockwise around their respective shafts 104, 105 can be arranged by an electric current flowing in coils, not show, located in winding slots like 202 provided in the half-arcs, the electric current creating a magnetic field in the magnetically permeable parts shown in FIG. 3. The winding slots and the wire turns of the coils therein are located in axial planes, i.e. planes passing through the axis of the brake.

FIG. 3 shows the magnetically permeable parts of the second (non-rotating) group. They include the two half arcs 102 and 103, their magnetically permeable shafts 104 and two pins 303 used to permit a path for the braking spring force. In FIGS. 1 and 2, the magnetically permeable parts are covered by other parts containing the winding slots like 202.

In the closed state shown, the two half arcs are in a position corresponding to a non-active brake caused by current flowing in the coils in the winding slots like 202.

FIG. 4 shows a flat spring suitable to provide the force required to create sufficient force between the friction lining 106 and the interior of the hollow cylinder 101.

FIG. 5 shows springs like 401 assembled in the brake of FIG. 2.

FIG. 6 shows a brake like that of FIGS. 1-5 assembled in an electric motor, e.g. a servo motor. The right end of the shaft 104 extending through the soft iron half-arc 301 is rigidly secured in the rear shield 602. The plastic coil support is visible as 601. The rotor shaft corresponds to the central shaft 108 of FIG. 1, and the motor rotor magnet holding cylinder corresponds to the hollow cylinder 101. The spring 401 is shown in suitable positions.

The force available over a magnetic air gap like 107 between the two half-arcs is very dependent on the length of the air gap (parallel with the flux lines). Spring loaded magnetically actuated brakes should have small air gaps to permit a large force from a small current. On the other hand, the air gap must be large enough to ensure that the friction surfaces used when the brake is active will be engaged when the brake is active and disengaged when the brake is passive. The required length of the air gap is therefore dependent of the mechanical tolerances in the parts in the brake force path. To overcome the mechanical tolerances of the parts in the force path, the air gap must be longer than the sum of the mechanical tolerances of these parts.

An advantage of the azimuthal or circumferential force path of the brake of FIGS. 1-6 is that the cost to get tight tolerances of cylindrical parts is comparatively low. The inside of a hollow cylinder like 101 with a diameter of 52.5 can easily be made with a tolerance class 6 corresponding to a diameter variation of 19 micrometers, i.e. is a radial uncertainty of 9.5 micrometers. Using similar rotation production technologies for the adjustment of the friction lining 106 on a set of two half-arcs with no air gap in position 107 can give a total uncertainty of for example 19 micrometers measured at the air gap 201 of the brake lining. This would require some 25 micrometer air gap in position 107 of FIG. 1 to cover the uncertainty of the mechanical dimensions of the parts used (the difference between 19 and 25 micrometers is caused by the distances from the shafts 104 and 105). Even after that margins have been added to handle other uncertainties, an air gap 107 of 70 micrometers instead of the 200 micrometers that are normal in spring actuated brakes permit an excitation current of some 35% of the conventional one and a power loss of some 10% of the power loss for the same device using a conventional air gap.

From this discussion it is obvious that the brake as described herein can be made have its mechanically critical dimension tolerances in the radial direction, utilising the fact that it is less expensive to manufacture radial dimensions with a high precision than axial dimensions. This can make the brake cost-efficient. Also, since short air gaps can be produced at a reasonable cost, the brake can be made to have a high torque to power loss ratio for the braking/releasing operation.

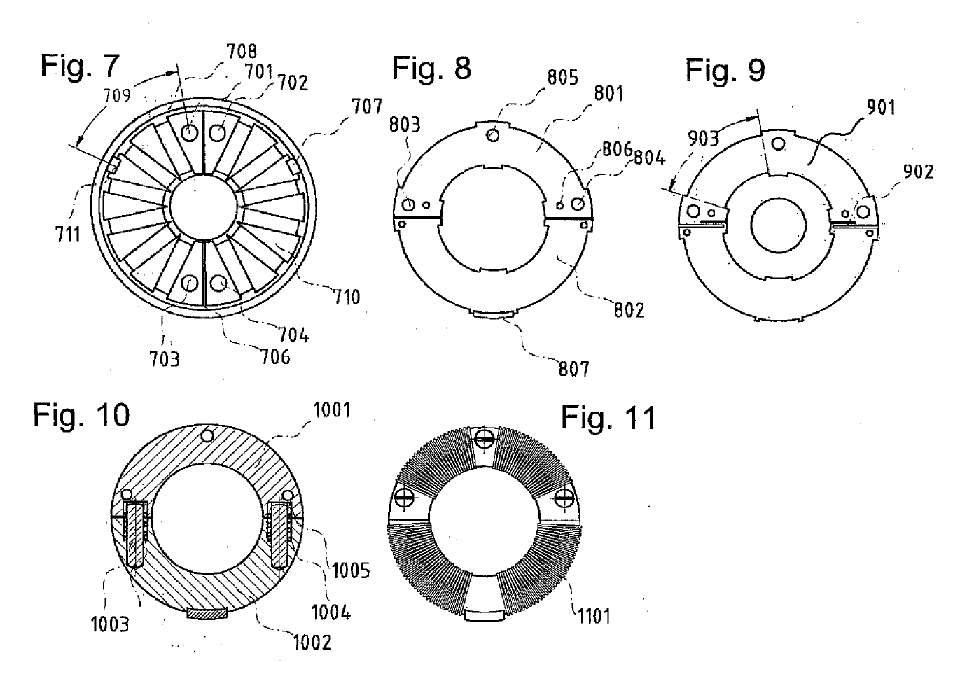

FIG. 7 shows a slightly different brake. The two parts may rotate slightly around the shafts 701 and 702. The required spring force is applied between pins 703 and 704.

The brake lining 707 will give a higher brake torque for a counter-clockwise movement of the brake drum 708 than for a clock-wise movement of the drum, as the friction force will cause an increase of the force perpendicular to the drum surface, causing a positive feedback. In the brake of FIG. 7, this is compensated by the fact that the brake torque from the other lining 711 will give lower brake torque for a counter-clockwise movement of the brake drum 708 than for a clockwise movement of the drum, thus giving a torque that is independent of the rotation direction. The brake shown in FIG. 1 will have a torque dependent on the rotation direction and may hence be suitable for e.g. robot parts moving against gravity.

The angle shown as 709 in FIG. 7 will affect the brake torque obtained for a given spring force. For a given magnetic air gap, there will be a corresponding possible spring force. If the angle 709 is reduced by another design of the position of the brake lining, the friction force and therefore the torque caused by a constant spring force will change. A given magnetic air gap will give different gaps between the brake lining like 711 and the brake drum depending on the angle 709.

Large values of the angle 709 combined with high friction coefficients for the lining—drum materials will result in a self-locking brake with a brake torque that is limited only by the breakdown of the weakest components.

FIG. 8 shows the magnetically active parts of a toroidal brake that has a parallel movement of the two parts. While such a brake can have two moving parts, the embodiment of FIG. 8 has one arc part 801 fixed to the chassis by screws in holes 803, 804, 805 and aligned by pins in holes like 806. The other arc part 802 moves vertically. With no electric current flowing in the coils described under item 903 and 1101 below, the two parts are separated by a spring force, and the lining 807 is pressed by the spring force against the interior surface of a drum.

FIG. 9 shows a flat spring 902 intended to be connected to the two parts 801-802 shown in FIG. 8. There are four winding slots like 903 which can be wound using toroidal winding machines.

FIG. 10 is a radial axial sectional view of a brake that has internal linear bearings and springs. The springs like 1004 are centered around pins like 1003 that are pressed into the moving arc part 1002 but can move smoothly inside bearings like 1005, that can be PTFE covered steel tubes.

FIG. 11 shows the winding 1101 of the brake of FIG. 10. The brake is shown in its no current, braking state in FIG. 10 and in its current carrying, not braking state in FIG. 11.

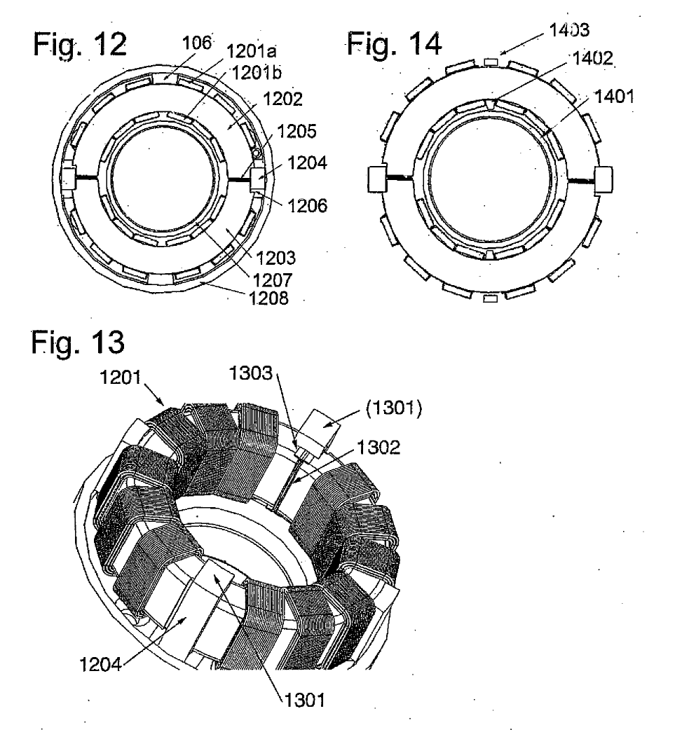

FIG. 12 is a radial axial sectional view of a parallel movement brake having the springs in the magnetic air gap. The brake is shown in its active (braking) state. It contains two half toroids 1202 and 1203. The half toroids are permitted to move inside a narrow space. Radially the half toroid 1202 is restricted against movements upward as seen in the drawing by the friction block 106 and the brake drum 1208. In the direction left, downwards and right it is limited by the stationary bars like 1204. These bars are preferably made of a material having a very low magnetic permeability such as some stainless steels.

FIG. 12 shows the brake after the drum 1208 has turned in the clockwise direction, thus moving the two half toroids in the clockwise direction. This has caused the half toroids to make a small clockwise rotation, causing a small gap indicated by arrow 1206 between the lower side of the stationary bar 1204 and the half toroid 1203 and a direct contact between the half toroid 1202 and the stationary bar 1204. Should there appear a counter-clockwise movement of the drum 1208, the two half toroids would move counter-clockwise and a gap would instead appear on the upper side of the stationary bar 1204.

The brake is shown with a hollow shaft 1207.

The springs are located in the gap 1205 but are not visible in any detail in FIG. 12.

FIG. 13 shows the brake of FIG. 12 in another view. The stationary bar 1204 shown only in a section in FIG. 12 is here shown complete. On its end there is a top part 1301 that restricts the movement of the half toroids in the axial direction. The springs 1302 act to separate the two half toroids. If there is no electric current flowing in the coils, the springs will separate the two half toroids until the friction blocks 106 are pressed against the drum 1208. In this state, there might be a total air gap between the two half toroids of some 0.4 mm. The springs are preferably made of steel having a high magnetic permeability, and the thickness of the spring material is not included in the air gap. When the coils are connected to a suitable DC voltage, the two half toroids are attracted by a force larger than the separating force from the springs, and the half toroids are then pressing against the stationary parts like 1204, leaving only a minor air gap in the order of 0-0.1 mm. It might be preferable to make sure that both half toroids press against the stationary parts like 1208 by intentionally designing the system so that a small air gap remains when the half toroids press against the bar 1204; this will fix the position of the half toroids so that they cannot vibrate freely.

FIG. 14 is a front view of a brake that is substantially similar to that of FIG. 12 except that it acts on the centre shaft 1401 through two friction blocks like 1402. This brake is active, i.e. is braking, when the controlling current in the coils is active. To limit the movement of the half toroids, blocking bars like 1403 are provided.

As is obvious for those skilled in the art, the invention shown can be varied in many ways. All embodiments shown have the friction blocks or pads 106 mounted to the outside of the half toroids or half-arcs pressing against the inside surface of a drum when there is no current in the windings. Obviously, if the friction blocks are moved to the inside of the half toroids and then pressing against a central shaft, the braking effect would appear when there is electric current flowing in the windings. Also, the embodiments shown have one drum part rotating while the half toroids and their associate hardware are stationary, thus giving a brake. Obviously, the half toroids and their associated hardware can be assembled on a rotating part, thus creating a clutch.

While specific embodiments of the invention have been illustrated and described herein, it is realized that numerous other embodiments may be envisaged and that numerous additional advantages, modifications and changes will readily occur to those skilled in the art without departing from the spirit and scope of the invention. Therefore, the invention in its broader aspects is not limited to the specific details, representative devices and illustrated examples shown and described herein. Accordingly, various modifications may be made without departing from the spirit or scope of the general inventive concept as defined by the appended claims and their equivalents. It is therefore to be understood that the appended claims are intended to cover all such modifications and changes as fall within a true spirit and scope of the invention. Numerous other embodiments may be envisaged without departing from the spirit and scope of the invention.

1-6. (canceled)

7. An electrically controlled brake or clutch including
a rotatable first mechanical system rotatable about a rotational axis and including at least one first friction part,
a second mechanical system including
at least one second friction part,
at least one winding to which a control electric current can be applied, the electric current creating a magnetic field having a main magnetic flux path comprising at least one air gap,
at least two soft magnetic parts arranged so that electric current flowing in the at least one winding affects magnetic fluxes through the at least two soft magnetic parts, at least one of said at least two soft magnetic parts arranged to be movable in a direction that affects the effective length of said at least one air gap, so that a control electric current in the at least one winding causes attraction forces over the air gap tending to move said at least one of said at least two soft magnetic parts to reduce the length of the air gap,
at least one spring, creating forces on said at least one of said at least two soft magnetic parts that is arranged to be movable, the forces acting in a direction substantially opposing said attraction forces created by an electrical current flowing in the at least one winding,
the first and second mechanical systems arranged to cause the at least one first friction part of the first mechanical system to be in frictional engagement or disengagement with the at least one friction part of the second mechanical system depending on the flux in the at least two soft magnetic parts, and
the at least two soft magnetic parts arranged so that the main magnetic flux path passes along a closed loop about the rotational axis of the first mechanical system,
wherein the at least one winding is mechanically fixed to or rigidly attached to one of the at least two soft magnetic parts.

8. The electrically controlled brake or clutch of claim 7, wherein the second mechanical system is stationary.

9. The electrically controlled brake or clutch of claim 7, wherein the second mechanical system also is rotatable about said rotational axis.

10. The electrically controlled brake or clutch of claim 7, wherein the at least one first friction part includes a cylindrical cavity and the at least one second friction part is located at least partly inside the cylindrical cavity, the first and second friction parts arranged so that fictional forces are created between an interior surface of the cylindrical cavity and a surface of the at least one secondary friction part.

11. The electrically controlled brake or clutch of claim 7, wherein the at least one first friction part includes a shaft having a cylindrical portion, and the at least one second friction part is located at least partly outside the cylindrical portion, the first and second friction parts arranged so that frictional forces are created between an outside surface of the cylindrical pint portion and the at least one secondary friction part.

12. The electrically controlled brake or clutch of claim 7, wherein the at least one spring is located inside said at least one air gap or in the direct vicinity thereof

13. The electrically controlled brake or clutch of claim 7, wherein the secondary mechanical system is located radially inside a cylindrical friction surface the first friction part and radially outside a cylindrical shaft, thus permitting a shaft having a substantial diameter to pass through the electrically controlled brake or clutch.

14. The electrically controlled brake or clutch of claim 7, wherein the at least one winding is mechanically fixed to or rigidly attached to the movable one of the two soft magnetic parts.

15. The electrically controlled brake or clutch of claim 7, wherein at least two windings are arranged and each of said at least two windings is mechanically fixed to or rigidly attached to a respective one of the at least two soft magnetic parts.

16. The electrically controlled brake or clutch of claim 15, wherein at least one of the windings is mechanically fixed to or rigidly attached to a movable soft magnetic part and at least one of the windings is mechanically fixed to or rigidly attached to a static soft magnetic part.
